(19) United States
(12) Patent Application Publication
(10) Pub. No.: US 2012/0159969 A1
(43) Pub. Date: Jun. 28, 2012

(54) Method for charging evaporators with cryogenically liquefied gases, and a device for carrying out said method

(75) Inventor: Werner Hermeling, Neusiedl am See (AT)

(73) Assignee: LO Solutions GmbH, Parndorf (AT)

(21) Appl. No.: 13/386,490

(22) PCT Filed: Jul. 22, 2010
(86) PCT No.: PCT/AT2010/000267

§ 371 Date: Mar. 13, 2012

(30) Foreign Application Priority Data
Jul. 22, 2009 (AT) GM 458/2009

(51) Int. Cl. F17C 5/00

(52) U.S. Cl. 62/45.1

(57) ABSTRACT

Within a method for loading evaporators (10) with cryogenically liquefied gases, a thermally insulated dosing container (10), to which gaseous pressure can be applied and a thermally insulated liquid dispenser (8) are connected upstream to the evaporator of which the connecting pipes can be blocked with the help of one valve each, while cryogenically liquefied gas is being charged into the dosing container (1). After opening the valve in the connecting pipe, cryogenically liquefied gas is brought from the dosing container (1) to the liquid dispenser (8). After introducing the cryogenically liquefied gas into the liquid dispenser (8) and subsequently closing the valve located in the connecting pipe, the cryogenically liquefied gas is transported from the liquid dispenser into a tubular evaporator (10), using the liquid's hydrostatic pressure, to which end, the valve between the liquid dispenser and the evaporator (10) is opened.

The invention relates to a method for loading evaporators with cryogenically liquefied gases as well as a device for carrying out this method.

As a rule, cryogenically liquefied gases are vaporised before use. To this end, evaporators are used, with vaporisation taking place using various heat carriers. In most cases, vaporisation starts spontaneously and uncontrollably. Liquid is introduced into evaporators using the pressure difference between the evaporator and a pressure booster unit, normally designed as a pump. Thus, the energy of the pump mechanism transfers the liquid into the evaporator. Subsequently, an outlet valve is used to separate it from the evaporator. Subject to the heat energy fed into the system, a transition from the liquid phase to gas phase or the supercritical state takes place. The pump must generate sufficient pressure to create a pressure difference large enough to enable the influx of the liquid into the evaporator. As a rule, pumps of this type require energy, generally provided in the form of electrical energy. The aim of the invention is to present a method for loading evaporators with cryogenically liquefied gases without the need for a separate pump.

In order to solve this object, the method for loading evaporators with cryogenically liquefied gases is carried out in the present invention as described below. A tank, a thermally insulated dosing container, to which gaseous pressure can be supplied, as well as a thermally insulated liquid dispenser are connected upstream to the evaporator, of which the connecting pipes can be blocked with the help of one valve each. The cryogenically liquefied gas from the tank is charged into the dosing container. Upon opening the valve located in the connecting pipe, the cryogenically liquefied gas is transferred from the dosing container to the liquid dispenser. After introducing the cryogenically liquefied gas into the liquid dispenser and subsequently closing the valve located in the connecting pipe, the cryogenically liquefied gas is transported from the liquid dispenser into a tubular evaporator, using the liquid's hydrostatic pressure. To this end, the valve between the liquid dispenser and the evaporator must be opened. When loading the liquid dispenser for the first time, the hydrostatic pressure of the cryogenically liquefied gas can be used. As the liquid dispenser itself is thermally insulated, no vaporisation will take place. Should the valve separating the liquid dispenser and the evaporator be subsequently opened, the cryogenically liquefied gas will enter a thermally non-insulated container and vaporise there while simultaneously increasing the pressure.

Preferably, the method should be carried out in such a manner that the pressure in the evaporator in excess of the pressure within the dosing container is applied to the dosing container. Thanks to this, there is no need for pumps to generate the pressure applied to the dosing container. Instead, the pressure generated during vaporisation can be directly applied. The content of the dosing container may also be pressed out into a further container, in which the pressure is lower than in the evaporator. When gas is fed back into the tank, a throttle can be used so that both the liquid phase and the gas phase are transferred into the tank.

To reduce heat input, the tank, the dosing container and the liquid dispenser(s) are vacuum-insulated. The containers may, however, also be cooled to ensure that the cryogenically liquefied gas does not vaporise before entering the evaporator, thus causing an undesirable increase in the pressure of the system. If a liquid coolant other than cryogenically liquefied gas is to be used, the own thermal capacity of the liquid coolant chosen should preferably be such as to ensure that the freezing point of the cryogenically liquefied gas cannot be reached. This prevents solidification of the cryogenically liquefied gas, with the lumps formed clogging the piping.

The device designed to carry out the method according to the present invention and comprising an insulated tank for cryogenically liquefied gas, at least one dosing container, connected using a pipe to an interposed valve and at least one evaporator should be constructed in such a way that an insulated liquid dispenser is located between the evaporator and the tank. The liquid dispenser should be equipped with an overflow pipe at its top end and a branch pipe equipped with a valve at the opposite end, both leading to the evaporator. Thanks to the interposition of an insulated liquid dispenser, the evaporator can be loaded without the cryogenically liquefied gas vaporising and thus causing an increase in pressure. Should the liquid dispenser be loaded until its top end, the cryogenically liquefied gas is conducted through the overflow pipe to the evaporator, causing a sudden increase in pressure. When detecting the pressure increase, the valve between the dosing container and the liquid dispenser is closed, and the valve in the branch pipe is opened so that the cryogenically liquefied gas can enter the evaporator and vaporise there. The liquid dispenser also has the additional function of bringing a pre-determined amount of cryogenically liquefied gas to the evaporator. Without interposition of a liquid dispenser, the cryogenically liquefied gas would vaporise instantly upon entering the evaporator, causing an increase in pressure so that no further amount of cryogenically liquefied gas could be transferred to the evaporator.

The device should preferably be constructed using a tubular evaporator and a tubular liquid dispenser. The tubular design enables low-cost insulation, especially vacuum insulation of the liquid dispenser, as well as better absorption of the high pressure generated during vaporisation.

In order to be able to operate the device according to the present invention without a pump, it should preferably be designed in such a way that a branch pipe equipped with a valve is located at the top end of the liquid dispenser, leading to the dosing container, or through a throttle to the tank. This design enables the increased pressure within the evaporator to be used for pressing out the content of the dosing container, so that use of a pump becomes unnecessary.

In order to ensure continuous operation, the device according to the present invention should preferably be designed in such a way that multiple evaporators are connected downstream to the dosing container, with a liquid dispenser connected upstream to each evaporator. Accordingly, appropriate connection of the valves enables the increased pressure within one of the evaporators to be used to press out the content of the dosing container into a liquid dispenser which is at a lower pressure level. With the help of a device of this kind, evaporators can be loaded continuously and without the need for a pump.

Temperatures well below the ambient temperature and the freezing point of water will occur at the latest upon cryogenically liquefied gas entering one of the evaporators, making a freeze-up inevitable. In order to prevent ice crystals from sticking, the device should preferably be designed in such a way that the evaporator is covered with nanocoating.

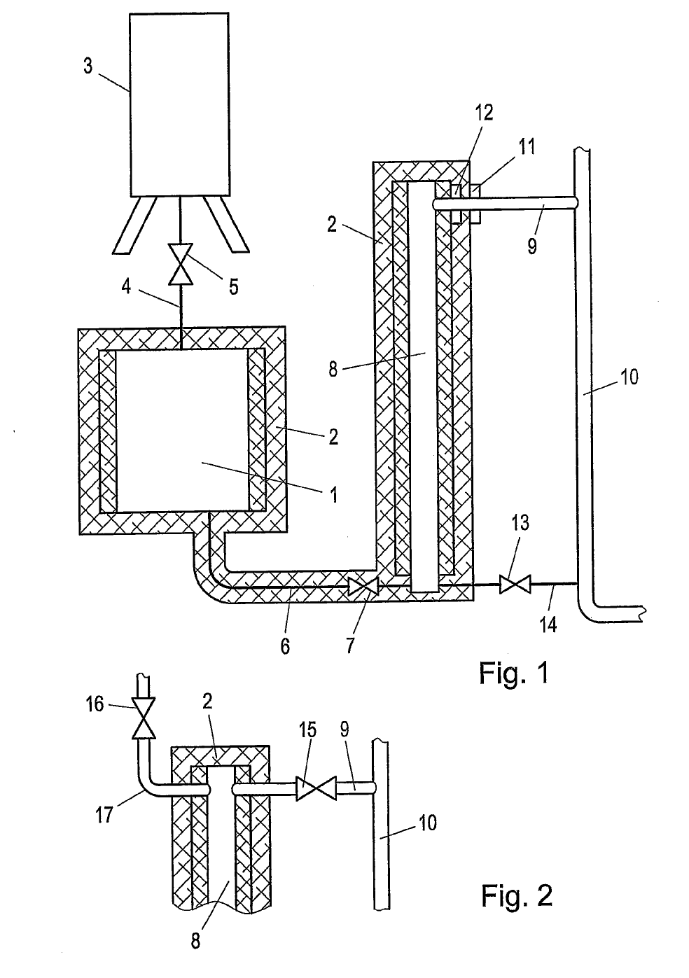

The sections presented below provide a more detailed description of the invention, based on an example of application illustrated schematically in the drawing. FIG. 1 shows a first design and FIG. 2 a second design of the device according to the present invention.

In FIG. 1, 1 indicates a dosing container, covered with a vacuum insulating layer 2. Following pressure compensation, cryogenically liquefied gas can be conducted from the tank 3 through a pipe 4 with an interposed valve 5 to the dosing container, using hydrostatic pressure. Subsequently, cryogenically liquefied gas is conducted through an insulated pipe 6 and an open valve 7 to the liquid dispenser 8, also covered with an insulating layer 2. If the liquid dispenser 8 is located below the dosing container 1, charging to the liquid dispenser 8 takes place free of pressure. The liquid dispenser 8 is at its top end equipped with an overflow pipe 9, breaking through the insulation layer 2 and not subsequently insulated. The overflow pipe 9 leads to a evaporator 10. Pressure sensors 11 are located at the outlet of the overflow pipe 9 from the insulating layer 2. Alternatively or additionally, liquid sensors 12 may be located at the top-end outlet of the overflow pipe 9 from the liquid dispenser 8. Upon the sensors detecting either an increase in pressure or the presence of liquid, the valve 7 is closed, and an amount defined on the basis of the volume of the liquid gas located in the liquid dispenser is available for vaporisation. In order to enable vaporisation, a valve 13 located at the lower end of the liquid dispenser 8 is opened, switching a pipe 14 which also leads to the evaporator 10. In this way, the cryogenically liquefied gas can flow into the evaporator and vaporise there.

FIG. 2 shows another possible design, with the outlet of a further pipe 17 from the liquid dispenser 8 located at the top end of the liquid dispenser 8 at the same height as the overflow pipe 9. This pipe 17 may be switched with the help of a further valve 16. This additional pipe also leads to the dosing container 1. The pressure increase generated by vaporisation can be used to press the content of the dosing container 1 into the liquid dispenser 8. This system does not comprise any pumps requiring frequent maintenance. In order to ensure continuous operation, at least two evaporators 10 should be equipped with one liquid dispenser 8 each, connected upstream, used alternatingly to apply pressure to the dosing container 1 or to press out the content of the dosing container 1 into the other liquid dispenser 8.

The evaporator may also be loaded with liquid directly from the tank, bypassing or omitting the liquid dispenser. In this case, an additional valve must be used to separate the liquid dispenser from the evaporator at its top end (and not only at its lower end). Following pressure compensation with the tank, the liquid dispenser is filled with liquid due to hydrostatic pressure, both valves open, and the pressure applied to the liquid dispenser causes the liquid to flow into the evaporator. After vaporisation, the closing of the valves ensures the separation of the liquid dispenser from the evaporator. At this point, the valve located between the top end of the liquid dispenser and the gas space of the tank open up to release the gas pressure building up through a throttle into the gas space of the liquid dispenser. Pressure will be applied to both gas and liquid phases. Pressure compensation will be completed, enabling for the liquid dispenser to be reloaded.

1. Method for loading evaporators with cryogenically liquefied gases, in which a tank (3), a thermally insulated dosing container (1), to which gaseous pressure can be applied, as well as a thermally insulated liquid dispenser (8) are connected upstream to the evaporator (10), whereupon the connecting pipe (4) in between the tank (3) and the dosing container (1) as well as the connecting pipe (6) in between the dosing container (1) and the liquid dispenser (8) can be blocked with the help of one valve (5, 7) each, whereby the cryogenically liquefied gas from the tank (3) is charged into the dosing container (1), whereupon after opening the valve (7) located in the connecting pipe (6) in between the dosing container (1) and the liquid dispenser (8), the cryogenically liquefied gas is transferred from the dosing container (1) to the liquid dispenser (8), whereby after introducing the cryogenically liquefied gas into the liquid dispenser (8) and subsequently closing the valve (7) located in the connecting pipe (6), the cryogenically liquefied gas is transported from the liquid dispenser (8) into a tubular evaporator (10), using the liquid's hydrostatic pressure in the liquid dispenser (8), whereby to this end, the valve (13) between the liquid dispenser (8) and the evaporator (10) is opened.

2. Method according to claim 1, characterised in that the pressure in the evaporator (10) in excess of the pressure in the dosing container (1) is applied to the dosing container (1).

3. Method according to claim 1, characterised in that in the case of use of a liquid coolant other than cryogenically liquefied gas, the own thermal capacity of the liquid is chosen such as to eliminate the possibility of the freezing point of the cryogenically liquefied gas being reached.

4. Device for carrying out the method according to claims 1, comprising an insulated tank (3) for cryogenically liquefied gas, an insulated dosing container (1), connected with the help of a pipe (4) to an interposed valve (5) and at least one evaporator (10), characterised in that an insulated liquid dispenser (8) is located between the evaporator (10) and the dosing container (1), and the liquid dispenser (8) is equipped with an overflow pipe (9) at its top end and a branch pipe (14) equipped with a valve (13) at the opposite end, both leading to the evaporator (10).

5. Device according to claim 4, characterised in that the evaporator (10) and the liquid dispenser (8) are tubular.

6. Device according to claim 4, characterised in that a branch pipe (17) equipped with a valve (16) is located at the top end of the liquid dispenser (8), leading to the dosing container (1) or through a throttle to the tank (3).

7. Device according to claim 4, characterised in that multiple evaporators (10) are connected downstream to the dosing container (1), with a liquid dispenser (8) connected upstream to each evaporator (10).

8. Device according to claim 4, characterised in that the evaporator (10) is covered with nanocoating.
